(19) United States
(12) Patent Application Publication
(10) Pub. No.: US 2012/0274530 A1
(43) Pub. Date: Nov. 1, 2012

(54) COUPLER

(75) Inventors: Takashi MINEMURA, Ome-shi (JP); Hiroshi SHIMASAKI, Kunitachi-shi (JP)

(73) Assignee: KABUSHIKI KAISHA TOSHIBA, Tokyo (JP)

(21) Appl. No.: 13/328,162

(22) Filed: Dec. 16, 2011

(30) Foreign Application Priority Data
Apr. 27, 2011 (JP) 2011-099743

(51) Int. Cl. H01Q 9/16

(52) U.S. Cl. 343/793

(57) ABSTRACT

According to one embodiment, a coupler includes a ground plane, a feed point connected to the ground plane, and an element having a unicursal-pattern. An electrical length of the element is not less than a wavelength corresponding to a central frequency of a desired frequency band, and is double the wavelength or less. The element includes a first segment disposed on a first plane, and a second segment disposed on the first plane or on a second plane which is opposed to the first plane with a gap and is parallel to the first plane, the second segment extending in parallel to the first segment. An electrical length of each of the first segment and the second segment is ½ of the wavelength or more, and is the wavelength or less.

### CROSS-REFERENCE TO RELATED APPLICATIONS

This application is based upon and claims the benefit of priority from prior Japanese Patent Application No. 2011-099743, filed Apr. 27, 2011, the entire contents of which are incorporated herein by reference.

### FIELD

Embodiments described herein relate generally to a coupler for transmitting and receiving an electromagnetic wave, for example, a coupler for use in close proximity wireless transfer.

### BACKGROUND

In recent years, development of close proximity wireless transfer technology is accelerated. The close proximity wireless transfer enables communication between two devices which are brought close together. Each of the devices having close proximity wireless transfer functions includes a coupler. When the two devices are brought closer within a transfer range, the couplers of the two devices are electromagnetically coupled. By this coupling, the devices can wirelessly transmit and receive signals.

A typical coupler includes, for example, a coupling electrode, a series inductor, a parallel inductor, and a ground plane. The series inductor and parallel inductor function as resonance modules. In this typical coupler, an infinitesimal dipole is formed by a charge of the coupling electrode and an image charge of the ground plane.

An infinitesimal dipole structure using an image charge of the ground plane is equivalent to an infinitesimal monopole antenna. Thus, in the coupler of the infinitesimal dipole structure, a large high-frequency current flows in the ground plane.

Incidentally, when a coupler is disposed within an electronic apparatus, it is possible that the coupler is in close proximity to peripheral components (peripheral metals) within the apparatus, or the coupler is surrounded by such peripheral metals. If a peripheral metal is brought close to the coupler, the electromagnetic radiation from the ground plane is greatly suppressed. Thus, the coupler of the infinitesimal dipole structure, wherein a large high-frequency current flows in the ground plane, is susceptible to the effect by the peripheral metal, and it is possible that the radiation efficiency of the coupler deteriorates due to the effect by the peripheral metal.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view illustrating a configuration example of a coupler according to an embodiment;

FIG. 2 is an exemplary view for explaining a direction of a high-frequency current flowing in the coupler according to the embodiment;

FIG. 3 is an exemplary view for explaining an electrical length of a line-shaped conductor of the coupler according to the embodiment, and an electrical length of a parallel segment portion in the line-shaped conductor;

FIG. 4 is an exemplary perspective view illustrating a configuration in a case where the coupler according to the embodiment is realized by a three-dimensional structure;

FIG. 5 is an exemplary view for explaining the direction of a high-frequency current flowing in the coupler of FIG. 4;

FIG. 6 is an exemplary view for explaining an electrical length of a line-shaped conductor of the coupler of FIG. 4 and an electrical length of a parallel segment portion in the line-shaped conductor;

FIG. 7 is an exemplary view illustrating an example of a mounting structure for mounting the coupler according to the embodiment on one side surface of a substrate;

FIG. 8 is an exemplary view illustrating an example of another mounting structure for mounting the coupler according to the embodiment on one side surface of the substrate;

FIG. 9 is an exemplary view illustrating an example of still another mounting structure for mounting the coupler according to the embodiment on one side surface of the substrate;

FIG. 10 is an exemplary view illustrating a structure of a top surface side of the substrate in a case of mounting the coupler according to the embodiment by using both surfaces of the substrate;

FIG. 11 is an exemplary view illustrating a configuration example of a back surface side of the substrate, this configuration example corresponding to the configuration example of the top surface side of the substrate shown in FIG. 10;

FIG. 12 is an exemplary view illustrating another configuration example of the top surface side of the substrate in the case of mounting the coupler according to the embodiment by using both surfaces of the substrate;

FIG. 13 is an exemplary view illustrating a configuration example of a back surface side of the substrate, this configuration example corresponding to the configuration example of the top surface side of the substrate shown in FIG. 12;

FIG. 14 is an exemplary view illustrating still another configuration example of the top surface side of the substrate in the case of mounting the coupler according to the embodiment by using both surfaces of the substrate;

FIG. 15 is an exemplary view illustrating a configuration example of a back surface side of the substrate, this configuration example corresponding to the configuration example of the top surface side of the substrate shown in FIG. 14;

FIG. 16 is an exemplary view illustrating still another configuration example of the top surface side of the substrate in the case of mounting the coupler according to the embodiment by using both surfaces of the substrate;

FIG. 17 is an exemplary view illustrating a configuration example of the back surface side of the substrate, this configuration example corresponding to the configuration example of the top surface side of the substrate shown in FIG. 16;

FIG. 18 is an exemplary view illustrating still another configuration example of the top surface side of the substrate in the case of mounting the coupler according to the embodiment by using both surfaces of the substrate;

FIG. 19 is an exemplary view illustrating a configuration example of the back surface side of the substrate, this configuration example corresponding to the configuration example of the top surface side of the substrate shown in FIG. 18;

FIG. 20 is an exemplary perspective view illustrating a structure of the coupler according to the embodiment, in the case of mounting the coupler by using both surfaces of the substrate;

FIG. 21 is an exemplary view showing an analysis result of an electric field distribution in the coupler of FIG. 20;

FIG. 22 is an exemplary view showing electric field intensity characteristics of the coupler of FIG. 20;

FIG. 23 is an exemplary view showing electric field intensity characteristics of the coupler according to the embodiment, which is mounted on one side surface of the substrate; and

FIG. 24 is an exemplary view illustrating a configuration example of a card device incorporating the coupler according to the embodiment.

### DETAILED DESCRIPTION

Various embodiments will be described hereinafter with reference to the accompanying drawings.

In general, according to one embodiment, a coupler comprises a ground plane, a feed point connected to the ground plane, and an element having a unicursal-pattern. The element comprises a first end connected to the feed point and a second end connected to a short-circuit point on the ground plane. An electrical length of the element is not less than a wavelength corresponding to a central frequency of a desired frequency band, and is double the wavelength or less. An electrical length between the feed point and the short-circuit point on the ground plane is ⅕ of the wavelength or less. The element comprises a first segment disposed on a first plane, and a second segment disposed on the first plane or on a second plane which is opposed to the first plane with a gap and is parallel to the first plane, the second segment extending in parallel to the first segment. An electrical length of each of the first segment and the second segment is ½ of the wavelength or more, and is the wavelength or less.

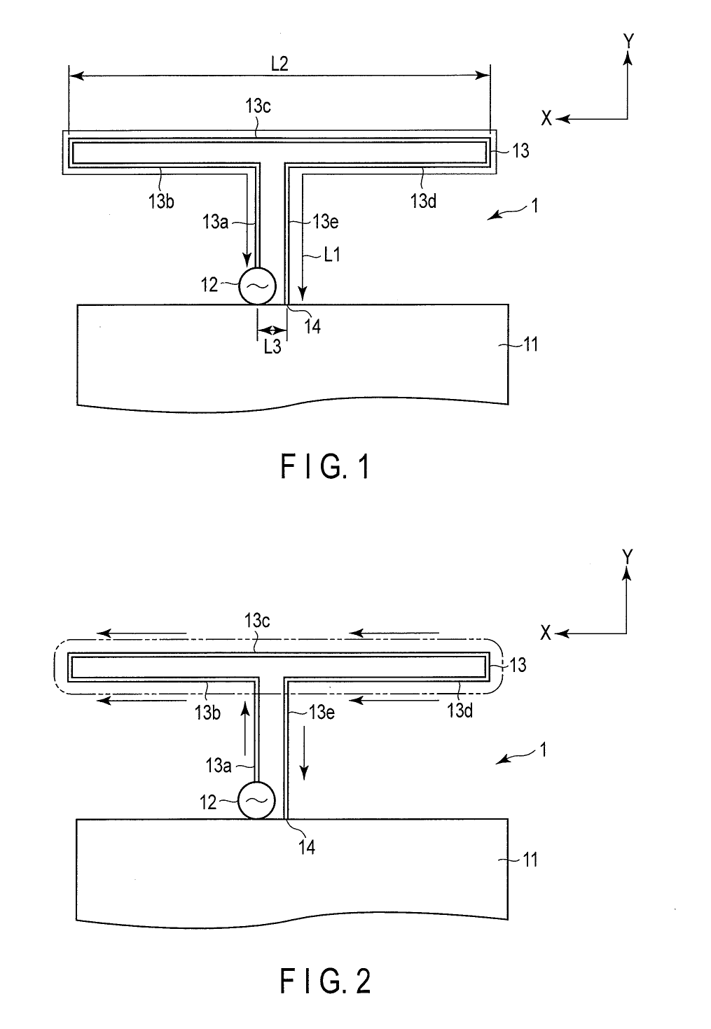

To begin with, referring to FIG. 1, the structure of a coupler 1 according to an embodiment is described. The coupler 1 transmits and receives electromagnetic waves by electromagnetic coupling between the coupler 1 and another coupler. The coupler 1 is used in close proximity wireless transfer. The close proximity wireless transfer executes data transfer between devices which are in close proximity. As the method of close proximity wireless transfer, for example, TransferJet™ can be used. TransferJet™ is a close proximity wireless transfer method which uses UWB (Ultra Wide Band).

As shown in FIG. 1, the coupler 1 comprises a ground plane 11, a feed point 12, an element 13 having a unicursal pattern (hereinafter referred to as “unicursal-line conductor 13”), and a short-circuit point 14. The ground plane 11 has a flat plate shape, and is substantially rectangular. The feed point 12 is connected to one side of the ground plane 11.

One end (low potential side) of the feed point 12 is connected to the ground plane 11. The unicursal-line conductor 13 is an elongated element and has a unicursal pattern. Specifically, the unicursal-line conductor 13 is an element having a unicursal pattern, i.e. a pattern defined by a continuous line drawn with one stroke. The unicursal-line conductor 13 is composed of a line-shaped conductor. One end (starting point) of the unicursal-line conductor 13 is connected to the feed point 12. The other end (terminating point) of the unicursal-line conductor 13 is connected to the short-circuit point 14 on one side of the ground plane 11. The short-circuit point 14 is a connection point (ground point) between the unicursal-line conductor 13 and the ground plane 11. The ground plane 11, feed point 12, unicursal-line conductor 13 and short-circuit point 14 are arranged on the same plane (X-Y plane). Further, the feed point 12 and short-circuit point 14 are disposed adjacent to each other at a middle portion of one side of the ground plane 11.

Although FIG. 1 shows the example in which the feed point 12 is positioned on the left side of the short-circuit point 14, the feed point 12 may be positioned on the right side of the short-circuit point 14.

In the present embodiment, the coupler 1 is configured such that parallel segment portions of the unicursal-line conductor 13 function as a main radiation element, thereby to realize a coupler structure which can reduce inflow of a high-frequency current to the ground plane 11.

The unicursal-line conductor 13 includes segment portions extending substantially in parallel to each other (hereinafter referred to as “parallel segment portion”). The unicursal-line conductor 13 is configured to operate in a mode (common mode) in which high-frequency currents in the same direction flow in the parallel segment portion. Arrows in FIG. 2 indicate the directions of high-frequency currents flowing in the unicursal-line conductor 13. In FIG. 2, a portion surrounded by a broken line is the parallel segment portion. The parallel segment portion extends in an X direction which is parallel to one side of the ground plane 11.

When the coupler 1 operates in the common mode, high-frequency currents in the same direction flow in two parallel paths of the parallel segment portion, as shown in FIG. 2. Thus, a large high-frequency current can be let to flow in the X direction, and a desired electric field radiation pattern can be generated.

In addition, in the common mode, high-frequency currents in opposite directions flow between the parallel segment portion of the unicursal-line conductor 13 and the ground plane 11. Specifically, the direction of a high-frequency current flowing between the feed point 12 and the unicursal-line conductor 13 and the direction of a high-frequency current flowing between the unicursal-line conductor 13 and the short-circuit point 14 are opposite to each other. Thus, the high-frequency current flowing from the ground plane 11 to the parallel segment portion and the high-frequency current flowing from the parallel segment portion to the ground plane 11 cancel each other. In an infinitesimal dipole structure using an image charge of a ground plane, a high-frequency current from a coupling electrode toward the ground plane mainly flows. Thus, in the coupler structure of the present embodiment, compared to the infinitesimal dipole structure, the inflow of high-frequency current to the ground plane 11 can be reduced.

Accordingly, in the coupler 1 of the embodiment, the parallel segment portion of the unicursal-line conductor 13 functions as a main radiation element, and the ground plane 11 is hardly used for electric field radiation. This means that even if the electric field radiation of the ground plane 11 is suppressed by a peripheral metal, the electric field radiation efficiency of the coupler 1 is hardly affected. Therefore, a sufficient radiation efficiency can be realized even under the condition that a peripheral metal is present. In addition, since the parallel segment portion extends in the X direction which is parallel to one side of the ground plane 11, the high-frequency current flows in the X direction. Thus, a desired electric field radiation pattern with a sufficiently high electric field intensity in the direction of communication (+Y direction) can be obtained.

Next, a description is given of a configuration example of the unicursal-line conductor 13 for realizing the above-described common mode.

As shown in FIG. 1, the unicursal-line conductor 13 comprises segments (line segments) 13a, 13b, 13c, 13d and 13e. The feed point 12 and short-circuit point 14 are disposed with a predetermined interval on an intermediate portion of one side of the ground plane 11. In this example, the short-circuit point 14 is disposed on a right side, as viewed from the feed point 12. One end of the segment 13a is connected to the feed point 12, and the segment 13a extends in a +Y direction, i.e. a direction perpendicular to the one side of the ground plane 11. One end of the segment 13e is connected to the short-circuit point 14, and the segment 13e extends in the +Y direction, i.e. the direction perpendicular to the one side of the ground plane 11.

One end of the segment 13b is connected to the other end of the segment 13a, and the segment 13b extends in a +X direction, i.e. a first direction from the intermediate portion to the left end of the one side of the ground plane 11. One end of the segment 13d is connected to the other end of the segment 13e, and the segment 13d extends in a −X direction, i.e. a second direction opposite to the first direction (a direction from the intermediate portion to the right end of the one side of the ground plane 11).

The segment 13c is a turn-back segment which connects the other end of the segment 13b and the other end of the segment 13d. The segment 13c includes a parallel segment portion extending in parallel to both the segment 13b and the segment 13d.

The path length of the unicursal-line conductor 13, i.e. an electrical length L1 of the unicursal-line conductor 13, is λ or more, and 2λ or less. λ is a wavelength corresponding to a central frequency of a desired frequency band. In other words, a minimum value of the electrical length L1 of the unicursal-line conductor 13 is λ, and a maximum value of the electrical length L1 of the unicursal-line conductor 13 is 2λ. The desired frequency band is a frequency band which is to be used for wireless communication (close proximity wireless transfer).

The distance between the feed point 12 and short-circuit point 14, i.e. an electrical length L3 between the feed point 12 and short-circuit point 14 on the ground plane 12, is ⅕ or less of the wavelength λ. The purpose of setting the electrical length L3 between the feed point 12 and short-circuit point 14 at ⅕ or less of the wavelength λ is to realize the above-described common mode, and to increase the input impedance of the coupler 1.

An electrical length L2 of a parallel segment portion of the unicursal-line conductor 13, i.e. the length of a parallel path which mainly contributes to radiation, is λ/2 or more, and λ or less. In other words, a minimum value of the electrical length L2 of the parallel segment portion is λ/2, and a maximum value of the electrical length L2 of the parallel segment portion is λ. The reason for this is as follows.

The reason why the maximum value of the electrical length L2 of the parallel segment portion is λ is that if the electrical length L2 of the parallel segment portion is greater than λ, it is possible that a current of the opposite phase may flow in the parallel segment portion. In addition, the reason why the minimum value of the electrical length L2 of the parallel segment portion is λ/2 is that if the electrical length L2 of the parallel segment portion is less than λ/2, the common mode does not easily occur.

The segments 13b, 13c and 13d function as the above-described parallel segment portion. The parallel segment portion is composed of a first segment which extends in parallel to the one side of the ground plane 11, and a second segment which extends in parallel to the first segment. Since the electrical length L3 between the feed point 12 and short-circuit point 14 is sufficiently short, the gap between the segment 13b and segment 13d can be substantially ignored. Thus, the segments 13b and 13d function as the above-described first segment. In addition, the segment 13c functions as the above-described second segment. The electrical length of each of the first segment and second segment is the electrical length L2 of the parallel segment portion.

The coupler 1 is electromagnetically coupled to another coupler which is present within a range of 10λ from the coupler 1, and executes communication with the another coupler.

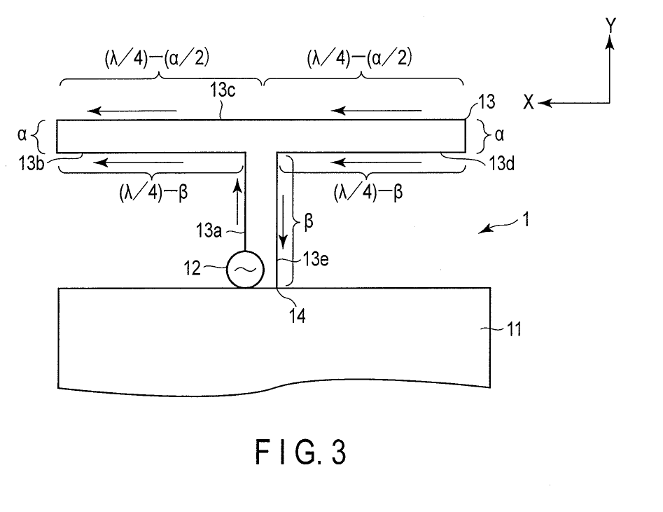

Next, referring to FIG. 3, a description is given of examples of the electrical lengths L1 and L2 of the unicursal-line conductor 13 of the coupler 1 of FIG. 1.

The total electrical length of the segment 13a and segment 13b is λ/4. The electrical length of each of the segments 13a and 13d is β. The electrical length of a small segment, which is present between the segment 13b and segment 13c, is α. Similarly, the electrical length of a small segment, which is present between the segment 13c and segment 13d, is α.

The value α is set in the following range:

(λ/100)<α<(λ/10).

This range of (λ/100)<α<(λ/10) is the range of the value α, in which the common mode can occur.

The value β is set in the following range:

(λ/50)<β<(λ/5).

This range of (λ/50)<β<(λ/5) is the range of a practical length of β, in which the common mode occurs.

The minimum value of the electrical length L1 of the unicursal-line conductor 13 can be given by:

$$\begin{matrix}L 1 = 4 ( ( λ / 4 ) - ( α / 2 ) ) + 2 α + 2 β \\ = λ - 2 α + 2 α + 2 β \\ = λ + 2 β \\ = λ + ( λ / 50 ) \\ \approx λ .\end{matrix}$$

The electrical length L2 of the parallel segment portion of the unicursal-line conductor 13 can be given by:

$$\begin{matrix}L 2 = ( λ / 4 ) - β + ( λ / 4 ) - ( α / 2 ) \\ = ( λ / 2 ) - β - ( α / 2 ) \\ = ( λ / 2 ) - ( λ / 50 ) - ( λ / 100 ) / 2 \\ \approx λ / 2.\end{matrix}$$

As has been described above, the coupler 1 of the embodiment is configured such that the parallel segment portion of the unicursal-line conductor 13 functions as a part which mainly contributes to radiation, thereby being able to reduce the inflow of high-frequency current to the ground plane 11. Therefore, the influence of a peripheral metal, which is present in the vicinity of the ground plane 11, can be reduced, and a high radiation efficiency of the coupler 1 can be maintained even in the state in which the coupler 1 is mounted within an electronic apparatus.

The structure of the coupler 1 is not limited to the planar structure as shown in FIG. 1. For example, the coupler 1 may be realized with a three-dimensional structure.

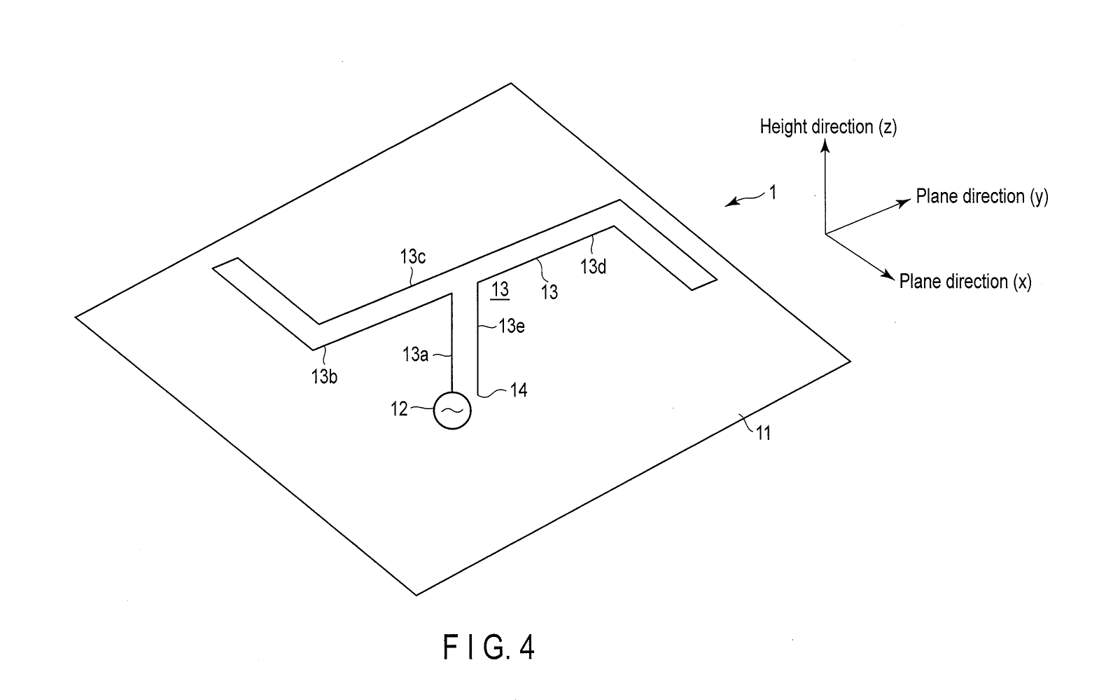

FIG. 4 illustrates a configuration example of a coupler 1 having a three-dimensional structure. A ground plane 11 is disposed on an X-Y plane. A parallel segment portion (segments 13b, 13c and 13d) of a unicursal-line conductor 13 is disposed on a plane which is opposed to the surface of the ground plane 11 with a gap. The parallel segment portion (segments 13b, 13c and 13d) is connected via a segment 13a, which extends in the Z direction, to a feed point 12 on the ground plane 11, and is connected via a segment 13e, which extends in the Z direction, to a short-circuit point 14 on the ground plane 11.

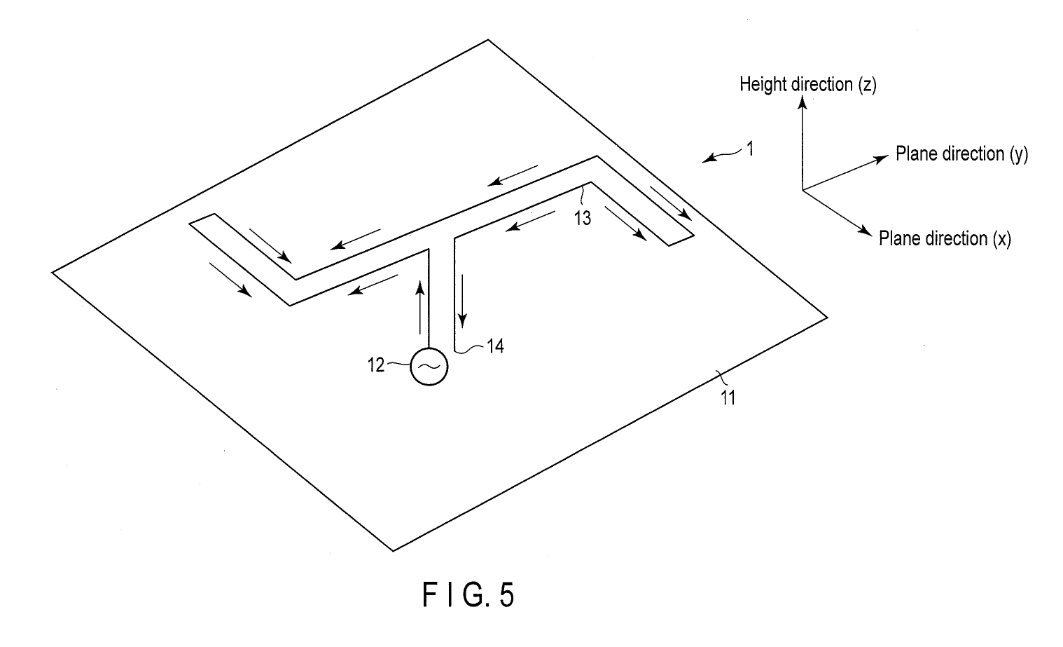

FIG. 5 illustrates high-frequency currents flowing in the coupler 1 of FIG. 4. Arrows in FIG. 5 indicates the directions of currents.

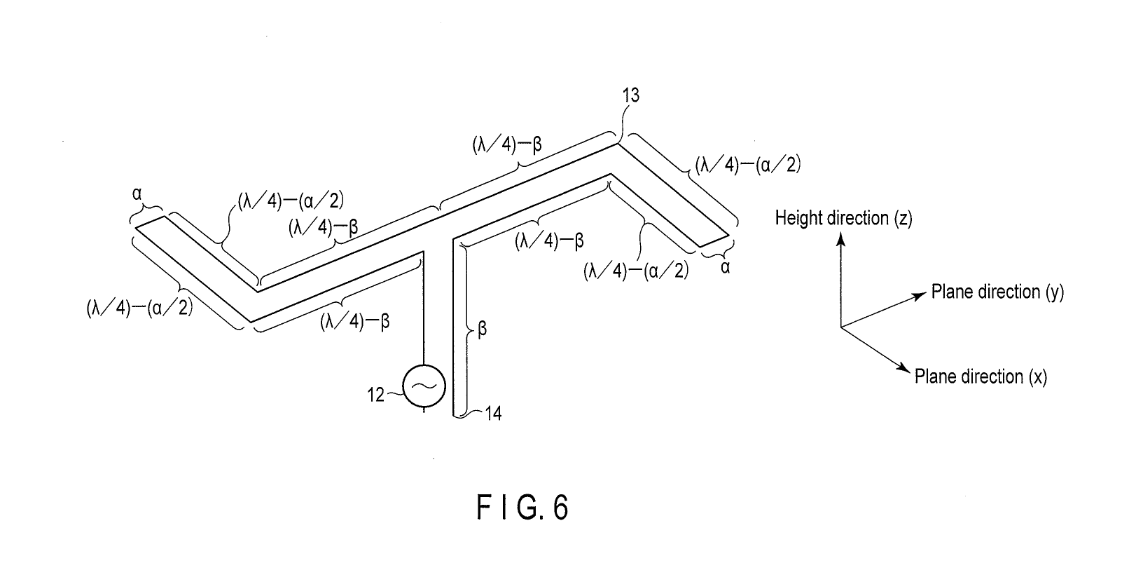

Next, referring to FIG. 6, a description is given of examples of electrical lengths L1 and L2 of the unicursal-line conductor 13 of the coupler 1 of the three-dimensional structure shown in FIG. 4.

The maximum value of the electrical length L1 of the unicursal-line conductor 13 can be given by:

$$\begin{matrix}L 1 = 4 ( ( λ / 4 ) - ( α / 2 ) ) + 4 ( ( λ / 4 ) - β ) ) + 2 α + 2 β \\ = λ - 2 α + λ - 4 β + 2 α + 2 β \\ = 2 λ - 2 β \\ = 2 λ + 2 ( λ / 50 ) \\ \approx 2 λ .\end{matrix}$$

The electrical length L2 of the parallel segment portion of the unicursal-line conductor 13 can be given by:

$$\begin{matrix}L 2 = 2 ( ( λ / 4 ) - β + ( λ / 4 ) - ( α / 2 ) ) \\ = 2 ( ( λ / 2 ) - β - ( α / 2 ) ) \\ = λ - 2 β - α \\ = λ - 2 ( λ / 50 ) - 2 ( λ / 100 ) \\ \approx λ .\end{matrix}$$

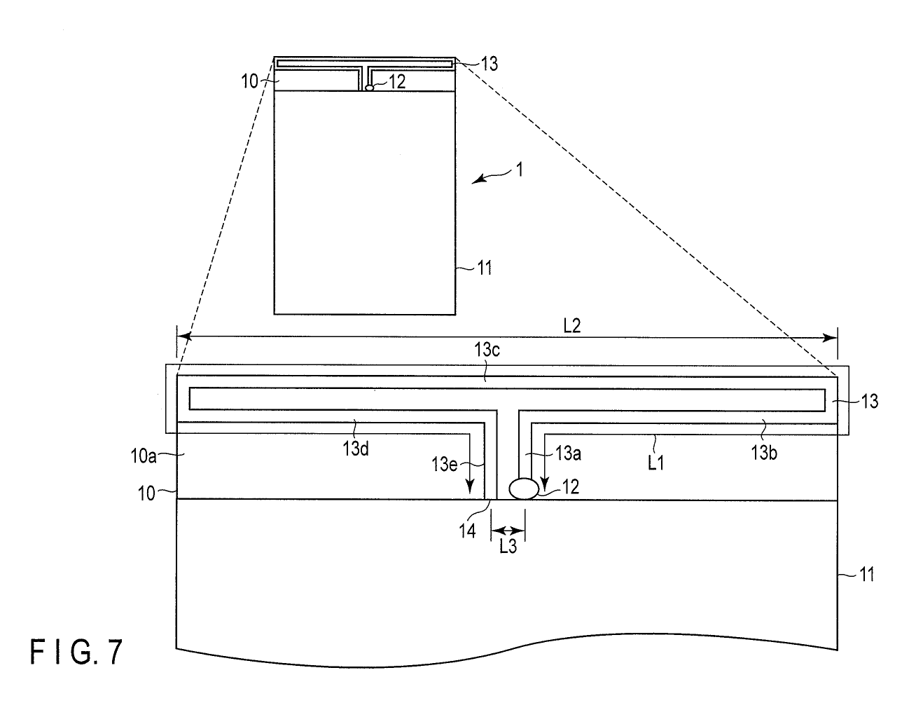

Next, referring to FIG. 7 to FIG. 9, a description is given of examples of a mounting structure for realizing the coupler 1 of the two-dimensional structure of FIG. 1. The case is described in which the coupler 1 is mounted on the surface of a substrate (dielectric substrate).

FIG. 7 shows a first example of the mounting structure for realizing the coupler 1 of the two-dimensional structure of FIG. 1. As shown in FIG. 7, the coupler 1 comprises a substrate (dielectric substrate) 10. The substrate 10 has a rectangular parallelepiped shape. The substrate 10 is a thin substrate. A ground plane 11, a feed point 12, a unicursal-line conductor 13 and a short-circuit point 14 are arranged on a first surface 10a of the substrate 10.

Incidentally, a parasitic element may additionally be provided on the first surface 10a of the substrate 10. For example, the parasitic element is disposed in parallel to the parallel segment portion of the unicursal-line conductor 13, within a range of λ/4 or less from the parallel segment portion. The parasitic element is not connected to the high potential side of the feed point 12 in terms of direct current, but is electrically connected to the high potential side of the feed point 12 in terms of high-frequency waves. By this parasitic element, the effect by the peripheral metal within the electronic apparatus can further be reduced.

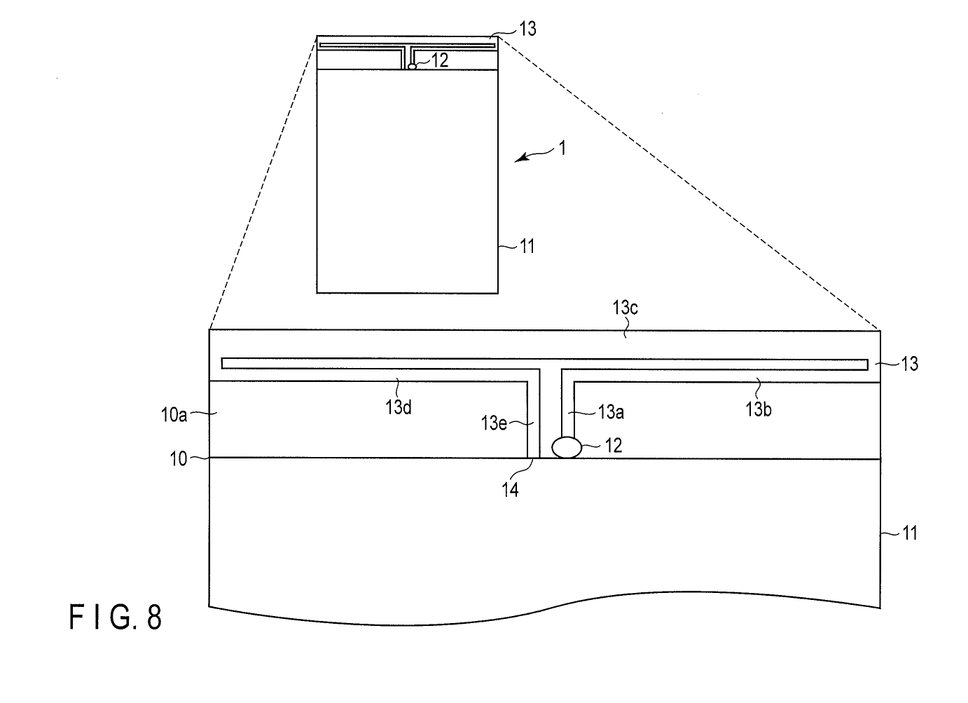

FIG. 8 shows a second example of the mounting structure for realizing the coupler 1 of the two-dimensional structure of FIG. 1.

The width of one segment (the width of segment 13c in this example) of the parallel segment portion is set to be greater than the width of the other segment (the width of each of segments 13b and 13d in this example) of the parallel segment portion. Thereby, the input impedance of the coupler 1 can be increased.

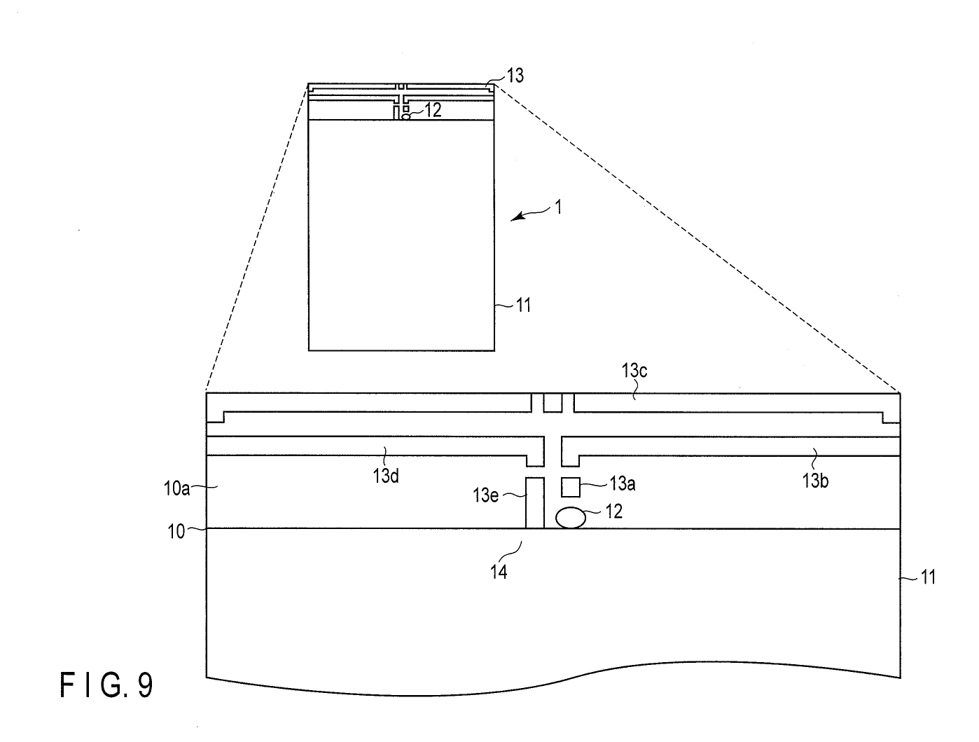

FIG. 9 shows a third example of the mounting structure for realizing the coupler 1 of the two-dimensional structure of FIG. 1. In FIG. 9, a plurality of gaps are arranged in the unicursal-line conductor 13. These gaps are used in order to arrange a lumped parameter component (chip component), such as an inductor, in the unicursal-line conductor 13.

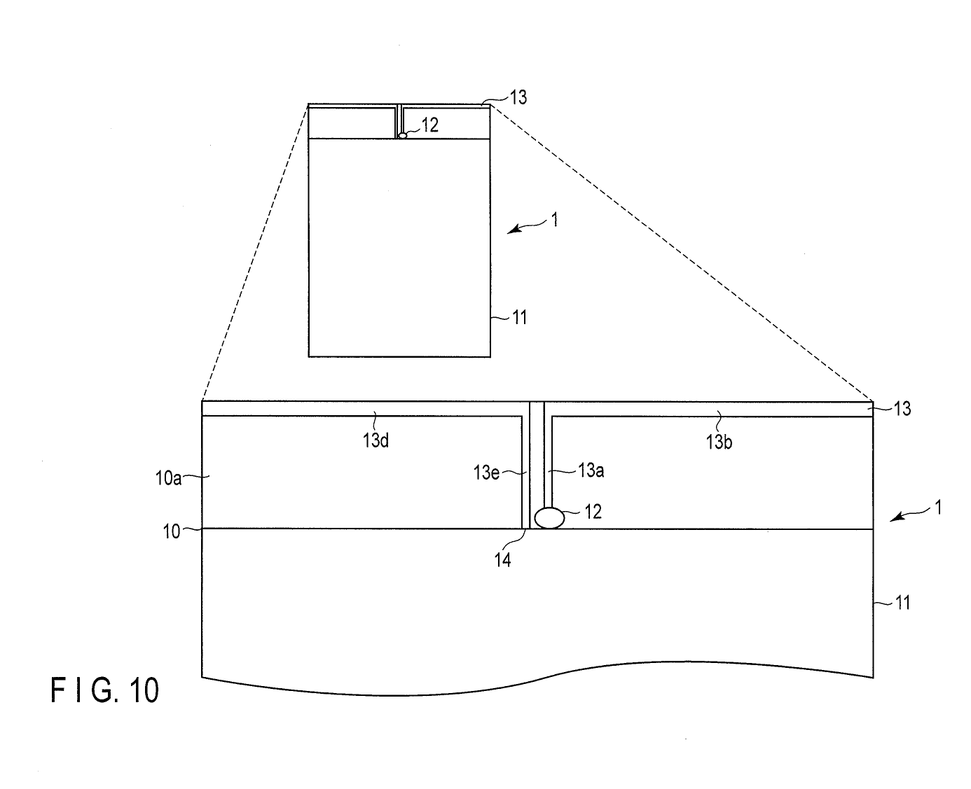

Next, referring to FIG. 10 to FIG. 19, a description is given of examples of the mounting structure for realizing a coupler 1 of a two-dimensional structure by using both surfaces of a substrate (dielectric substrate).

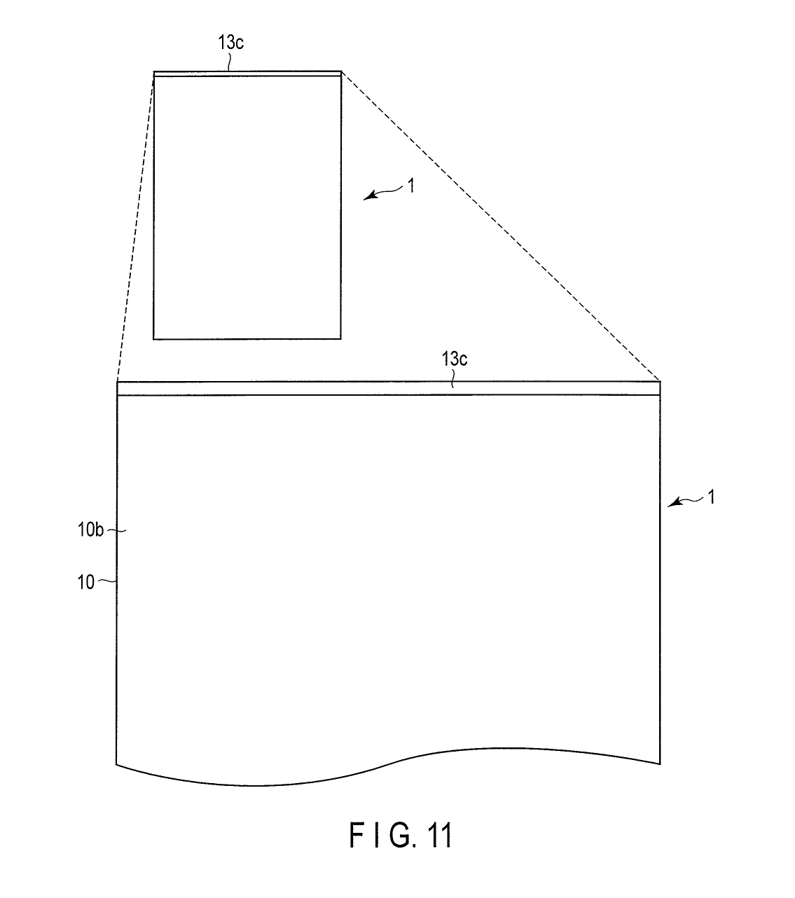

FIG. 10 and FIG. 11 show a first example of the coupler mounting structure using both surfaces of the substrate. FIG. 10 shows the structure of a coupler 1 which is disposed on a first surface 10a of a substrate (dielectric substrate) 10, and FIG. 11 shows the structure of the coupler 1 which is disposed on a second surface (back surface) 10b of the substrate 10.

A ground plane 11, a feed point 12, a part (segments 13a, 13b, 13d and 13e) of a unicursal-line conductor 13, and a short-circuit point 14 are arranged on the first surface 10a of the substrate 10. The other part (segment 13c) of the unicursal-line conductor 13 is disposed on the second surface (back surface) 10b of the substrate 10. The segment 13c on the second surface (back surface) 10b of the substrate 10 extends in parallel to the direction of extension of the segments 13b and 13d on the first surface 10a of the substrate 10.

In other words, a first segment (segment 13b, 13d) of the parallel segment portion is disposed on a first plane (surface 10a). A second segment (segment 13c) of the parallel segment portion is disposed on the second surface 10b. The second surface 10b is a second plane, which is opposed to the first plane with a gap and is parallel to the first plane. The second segment (segment 13c) is opposed to the first segment (segment 13b, 13d) and extends in parallel to the first segment (segment 13b, 13d).

One end of the segment 13b (a right end of the segment 13b in FIG. 10) is connected to the segment 13c on the second surface (back surface) 10b via a via-hole (through-hole) in the substrate 10. Similarly, one end of the segment 13d (a left end of the segment 13d in FIG. 10) is connected to the segment 13c on the second surface (back surface) 10b via another via-hole (through-hole) in the substrate 10.

Needless to say, instead of using the via-holes, the segment 13b and segment 13c may be connected via a wiring pattern on a right side surface of the substrate 10, and the segment 13d and segment 13c may be connected via a wiring pattern on a left side surface of the substrate 10.

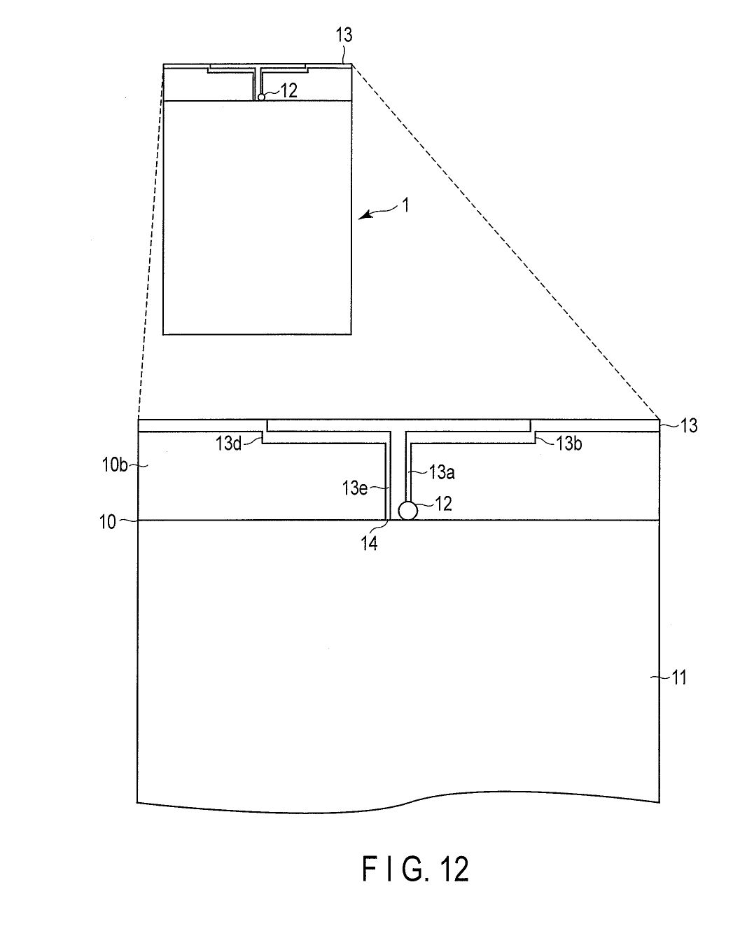

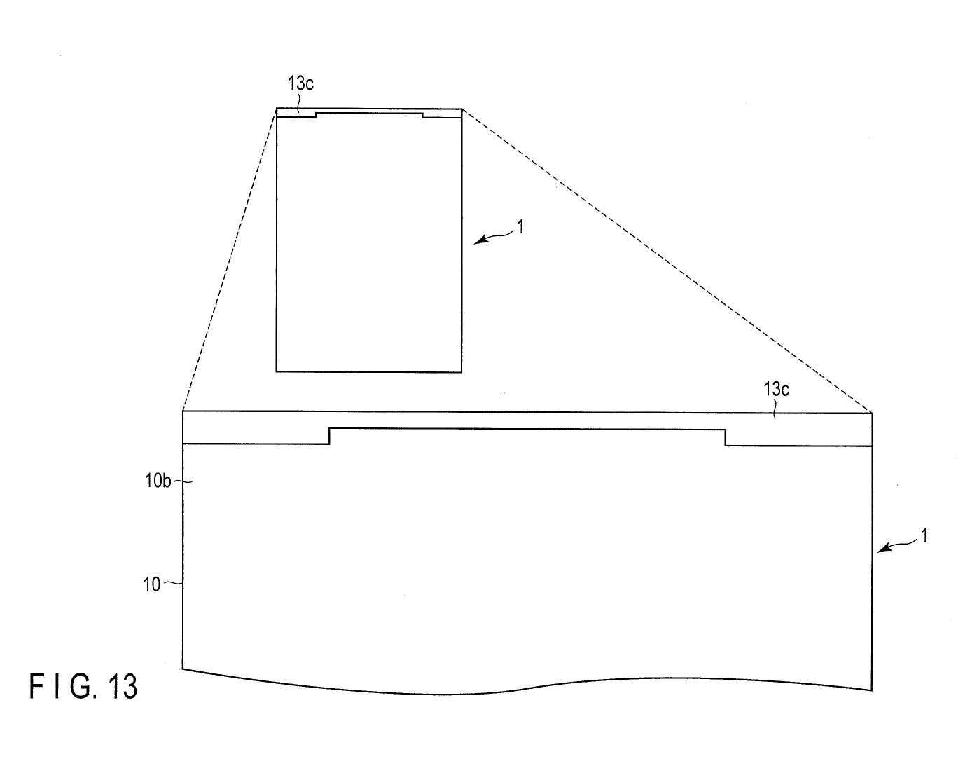

FIG. 12 and FIG. 13 show a second example of the coupler mounting structure using both surfaces of the substrate. FIG. 12 shows the structure of a coupler 1 which is disposed on the first surface 10a of the substrate 10, and FIG. 13 shows the structure of the coupler 1 which is disposed on the second surface (back surface) 10b of the substrate 10.

In the second example of the coupler mounting structure, one of a first segment (segment 13b, 13d) and a second segment (segment 13c) of the parallel segment portion includes a portion which is not opposed to the other of the first segment (segment 13b, 13d) and second segment (segment 13c).

In the example of FIG. 12, a portion of the segment 13b (a substantially left half portion of the segment 13b in this example) is located at a position that is lower than that position on the first surface 10a, which is opposed to a position of disposition of the second segment (segment 13c) on the second surface 10b, that is, at a position biased toward the ground plane 11 from the position of disposal of the second segment (segment 13c). Similarly, a portion of the segment 13d (a substantially right half portion of the segment 13d in this example) is located at a position that is lower than that position on the first surface 10a, which is opposed to a position of disposition of the second segment (segment 13c) on the second surface (back surface) 10b, that is, at a position biased toward the ground plane 11 from the position of disposal of the second segment (segment 13c). Accordingly, the substantially left half portion of the segment 13b and the substantially right half portion of the segment 13d are not opposed to the second segment (segment 13c) on the second surface 10b.

In other words, the central position in the width direction of the substantially left half portion of the segment 13b is located on the outside (lower side) of the width of the second segment (segment 13c) on the second surface (back surface) 10b. Similarly, the central position in the width direction of the substantially right half portion of the segment 13d is located on the outside (lower side) of the width of the second segment (segment 13c) on the second surface (back surface) 10b.

Thereby, the substantially left half portion of the segment 13b and the substantially right half portion of the segment 13d do not overlap the second segment (segment 13c) on the second surface 10b. As described above, the substrate 10 is thin. Thus, if the entirety of the first segment and the entirety of the second segment are disposed at positions which are opposed to each other via the substrate 10, it is possible that a current in a direction opposite to the direction of a high-frequency current flowing in the first segment is induced in the second segment by the high-frequency current flowing in the first segment.

In the present embodiment, the first segment (segment 13b, 13d) has such a pattern that at least a portion of the first segment is laid out so as not to be opposed to the second segment (segment 13c). Therefore, the induction of a current in the opposite direction can be prevented, and a desired current distribution on the parallel segment portion can easily be realized.

In the meantime, as shown in FIG. 13, the width (line width) of an intermediate portion of the second segment (segment 13c) on the second surface 10b may be made less than the line width of both end portions of the second segment (segment 13c). Thereby, simply by slightly shifting the position of disposition of the first segment (segment 13b, 13d), the parallel segment portion can be provided with a portion at which the first segment (segment 13b, 13d) and the second segment (segment 13c) do not overlap.

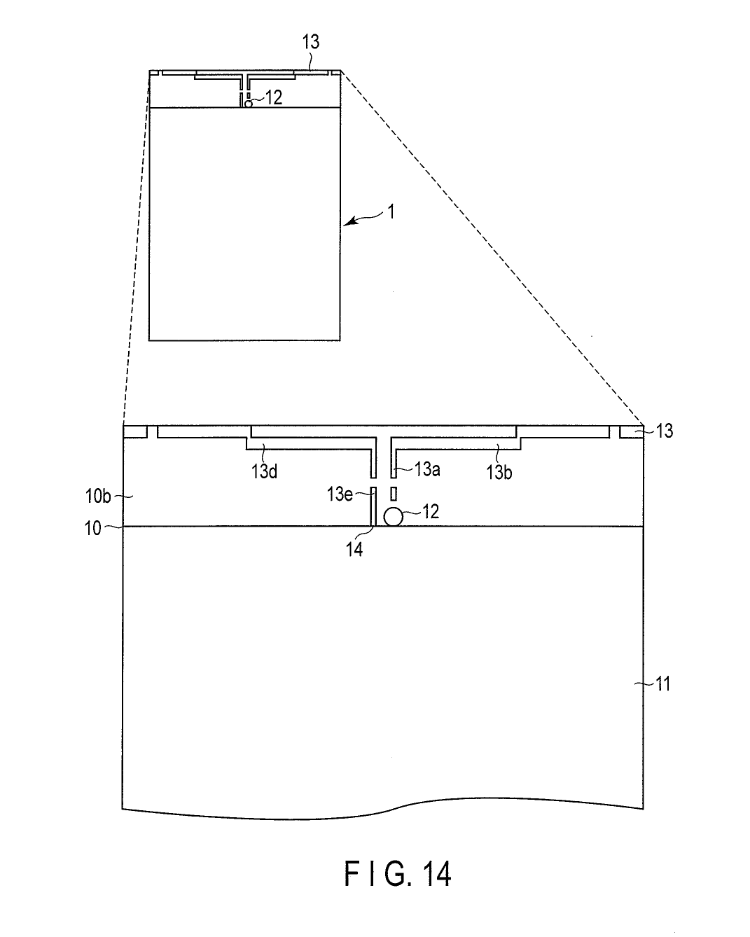

FIG. 14 and FIG. 15 show a third example of the coupler mounting structure using both surfaces of the substrate. FIG. 14 shows the structure of a coupler 1 which is disposed on the first surface 10a of the substrate 10, and FIG. 15 shows the structure of the coupler 1 which is disposed on the second surface (back surface) 10b of the substrate 10.

In the configuration example of FIG. 14 and FIG. 15, like the configuration described with reference to FIG. 12 and FIG. 13, the parallel segment portion is provided with a portion at which the first segment (segment 13b, 13d) and the second segment (segment 13c) do not overlap. Furthermore, a plurality of gaps are provided in the unicursal-line conductor 13.

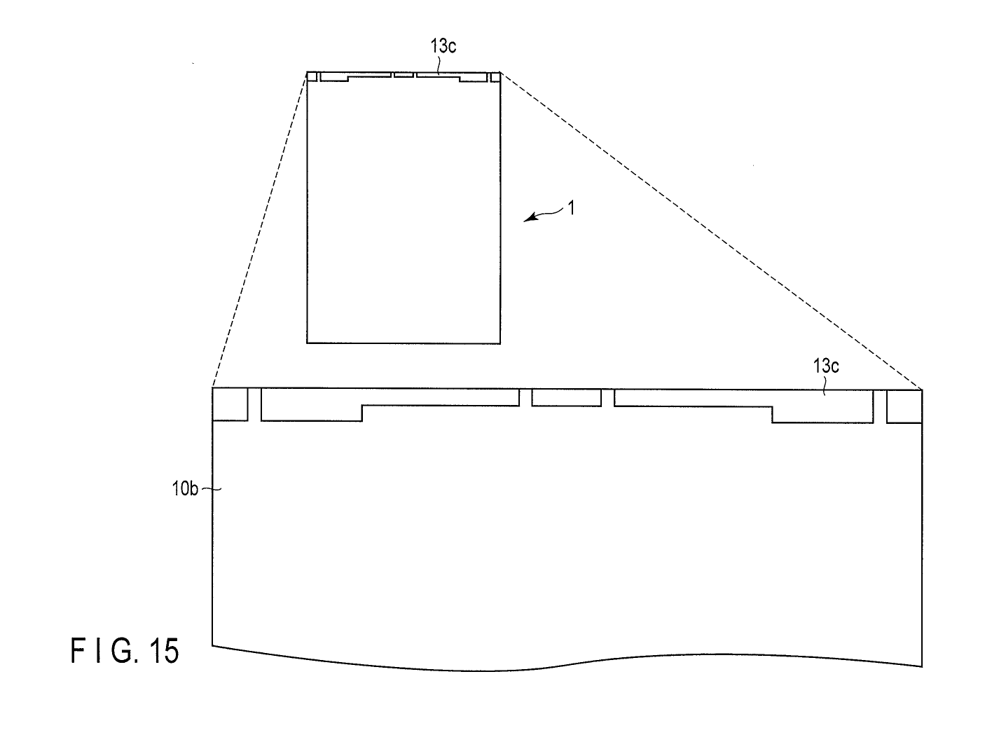

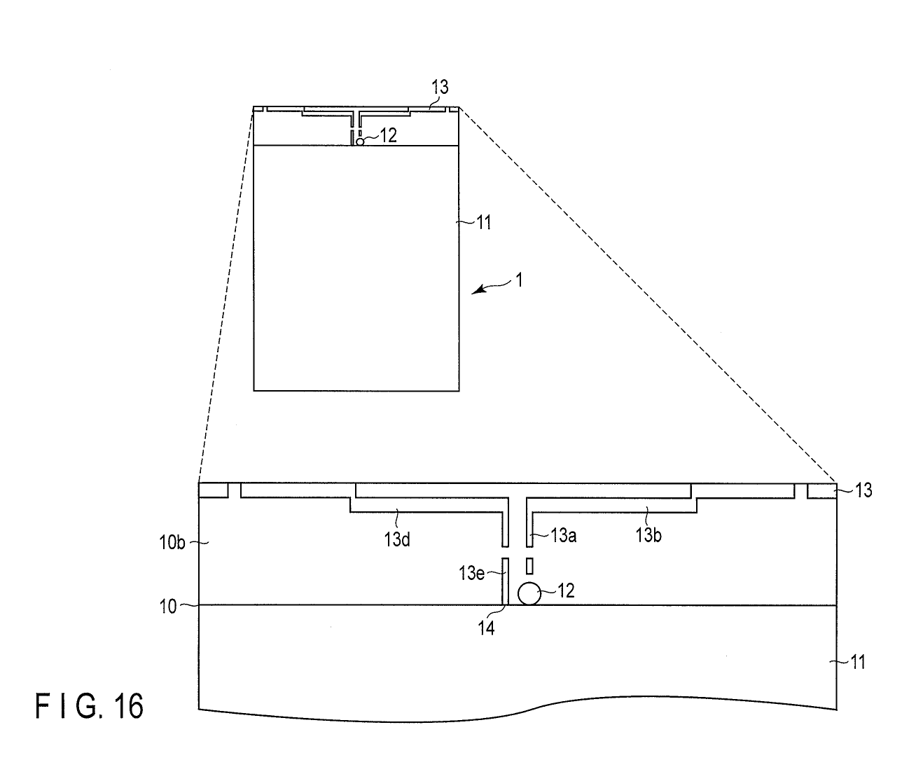

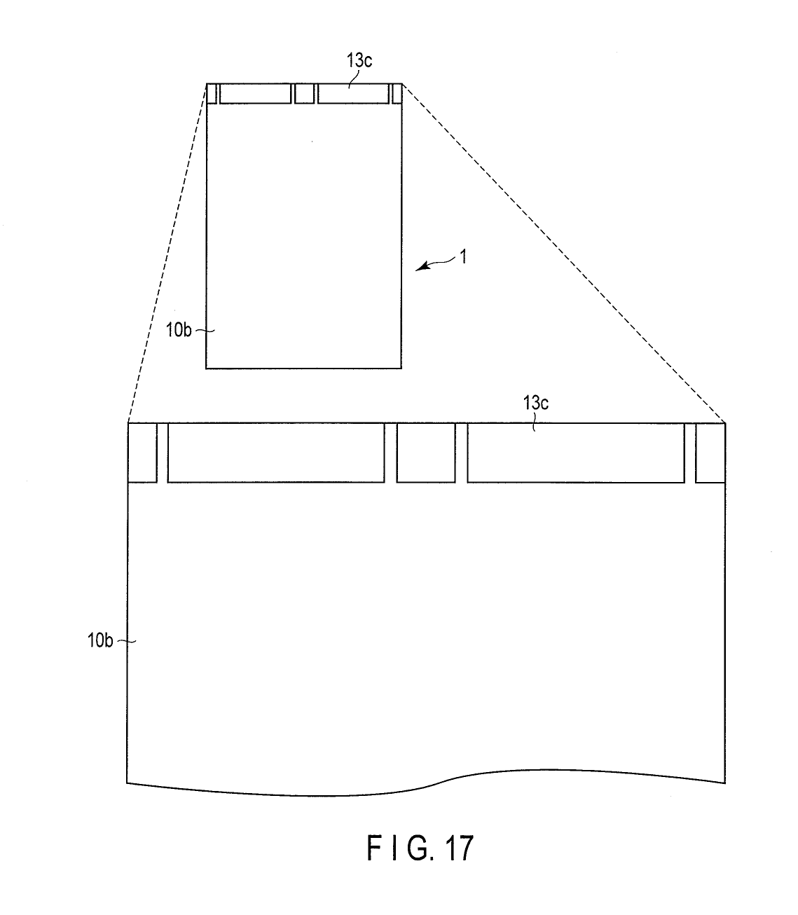

FIG. 16 and FIG. 17 show a fourth example of the coupler mounting structure using both surfaces of the substrate. FIG. 16 shows the structure of a coupler 1 which is disposed on the first surface 10a of the substrate 10, and FIG. 17 shows the structure of the coupler 1 which is disposed on the second surface (back surface) 10b of the substrate 10.

As shown in FIG. 17, the width of the second segment (segment 13c) on the second surface (back surface) 10b is greater than the width of the first segment (segment 13b, 13d) on the first surface 10a. Thereby, the input impedance of the coupler 1 can be increased, although the first segment (segment 13b, 13d) and the second segment (segment 13c) are opposed to each other.

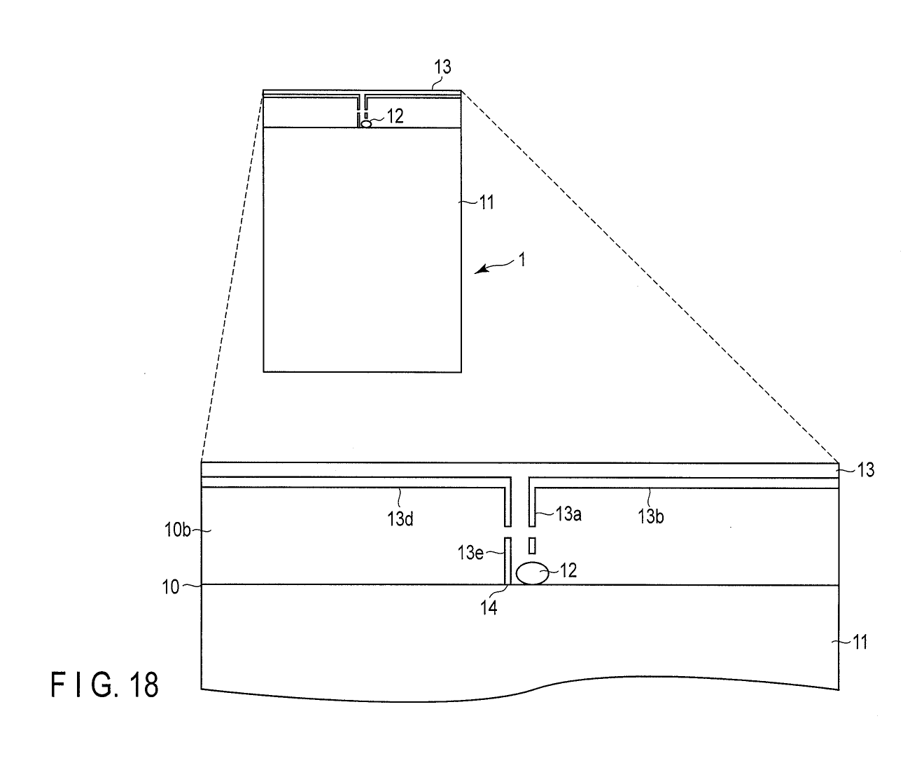

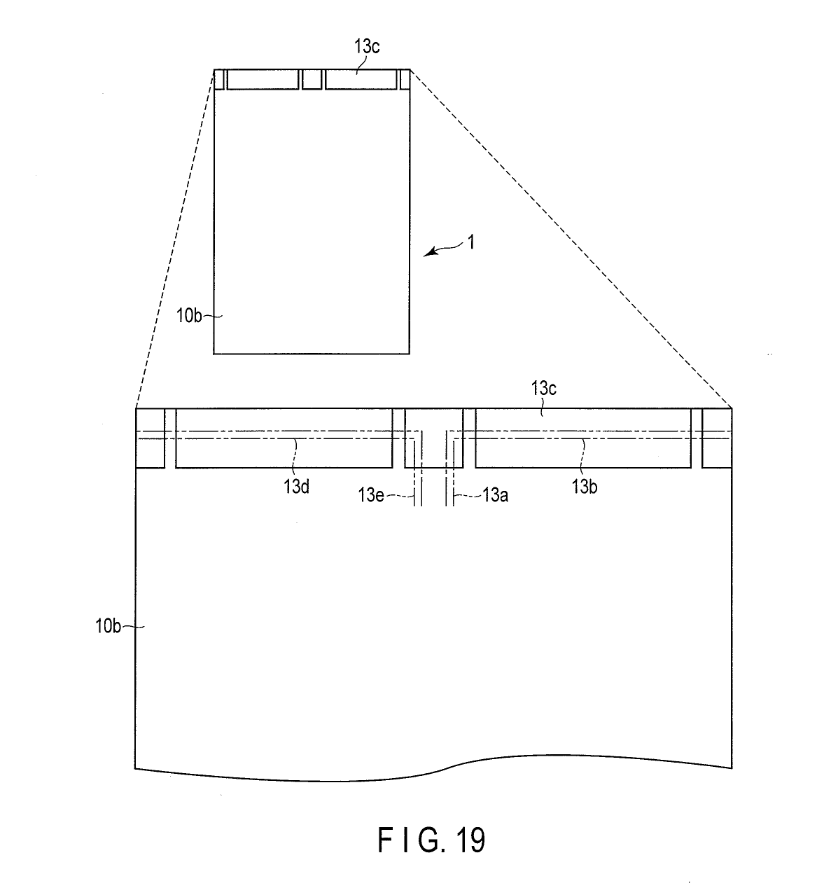

FIG. 18 and FIG. 19 show a fifth example of the coupler mounting structure using both surfaces of the substrate. FIG. 18 shows the structure of a coupler 1 which is disposed on the first surface 10a of the substrate 10, and FIG. 19 shows the structure of the coupler 1 which is disposed on the second surface (back surface) 10b of the substrate 10.

As shown in FIG. 18 and FIG. 19, the first segment (segment 13b, 13d) on the first surface 10a has a smaller width than the second segment (segment 13c) on the second surface (back surface) 10b. The width of the first segment (segment 13b, 13d) is, for example, ⅓ or less, preferably ¼ or less, of the width of the second segment (segment 13c). In addition, the first segment (segment 13b, 13d) is opposed to the second segment (segment 13c) on the second surface (back surface) 10b via the substrate 10, and extends along the center line in the longitudinal direction of the second segment (segment 13c). In general, the electric field at the central position in the width (line width) of a segment (line segment) is lower than the electric field at either side of the segment (line segment). Thus, by making the first segment (segment 13b, 13d) extend along the center line in the longitudinal direction of the second segment (segment 13c), a current in the opposite phase is hardly induced even in the state in which the first segment (segment 13b, 13d) and the second segment are opposed via the substrate 10.

In the meantime, the width of the first segment (segment 13b, 13d) may be made greater than the width of the second segment (segment 13c), and the second segment (segment 13c) may be made to extend along the center line in the longitudinal direction of the first segment (segment 13b, 13d).

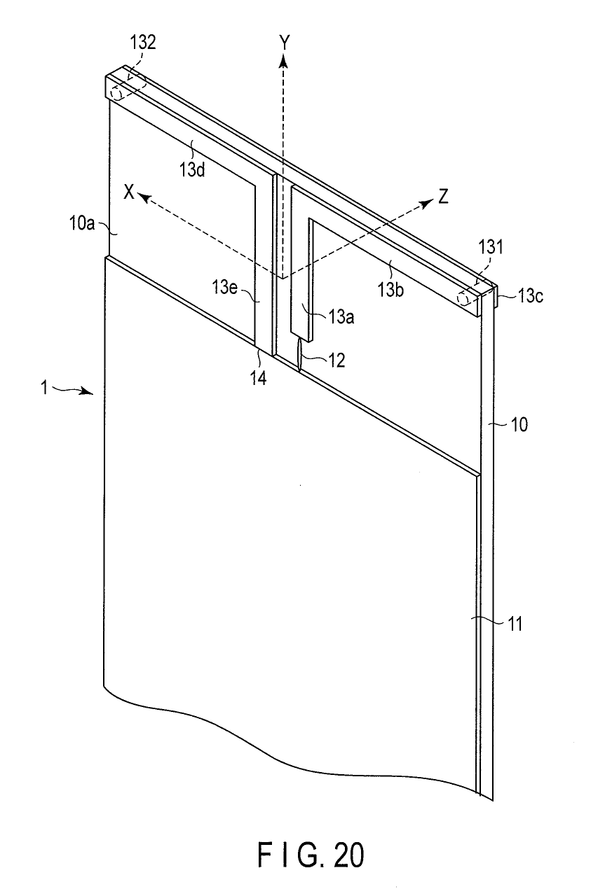

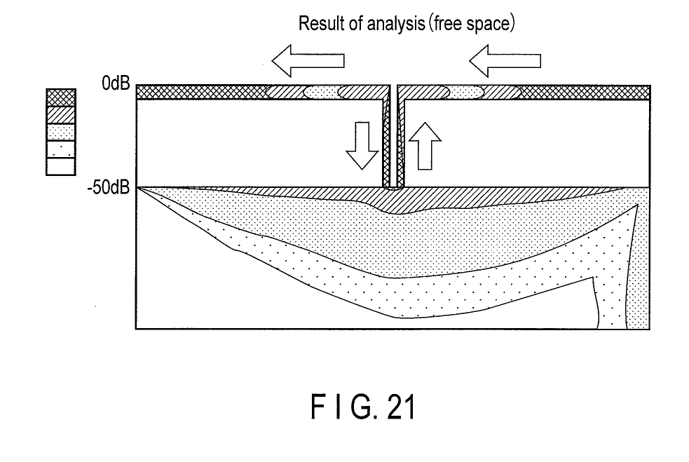

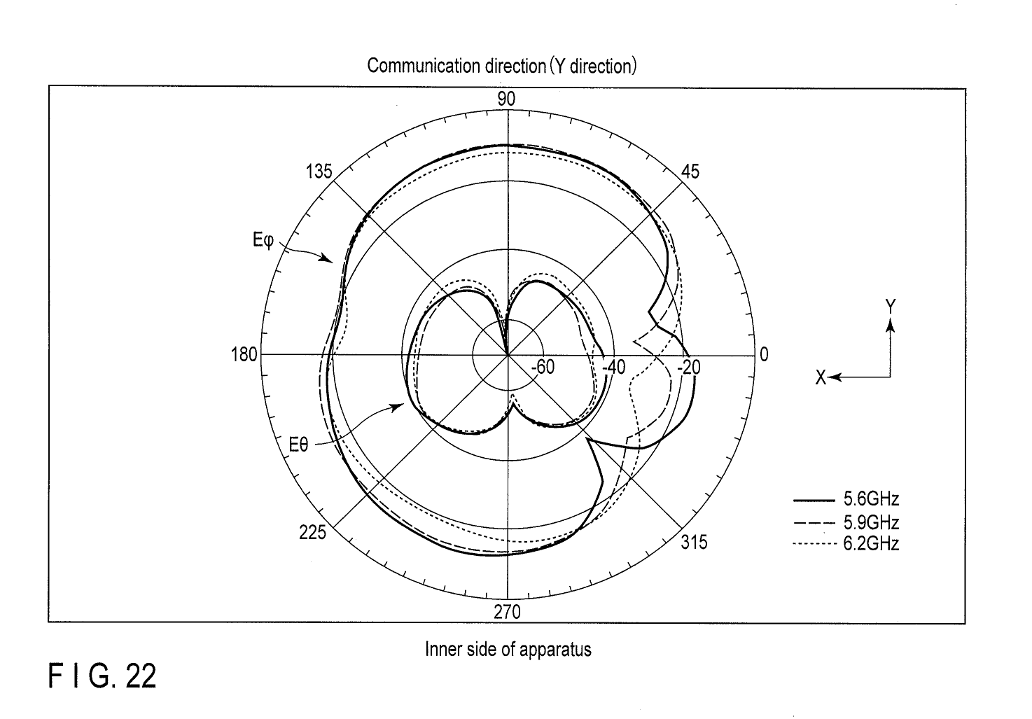

Next, referring to FIG. 20, FIG. 21 and FIG. 22, the characteristics of the coupler mounting structure using both surfaces of the substrate are described.

FIG. 20 is a perspective view illustrating a mounting structure of a coupler 1 which was used for analysis of characteristics. A ground plane 11, a feed point 12 and segments 13a, 13b, 13d and 13e of a unicursal-line conductor 13 are arranged on a surface 10a of a thin dielectric substrate 10. The segments 13a and 13e extend in the Y direction, and the segments 13b and 13d extend in the X direction.

The feed point 12 is connected to an intermediate portion of one side of the ground plane 11 (an intermediate portion in the longitudinal direction). The unicursal-line conductor 13 extends in a unicursal fashion from the feed point 12 as a starting point, and a terminating point of the unicursal-line conductor 13 is connected to a short-circuit point 14 which is present on the intermediate portion of the one side of the ground plane 11.

One end of the segment 13a is connected to the feed point 12, and the segment 13a extends from the feed point 12 in a direction perpendicular to the direction of extension of the one side of the ground plane 11. One end of the segment 13b is connected to the other end of the segment 13a. The segment 13b extends from a position near the center of the substrate 10 toward the right side surface in parallel to the one side of the ground plane 11.

One end of the segment 13e is connected to the short-circuit point 14, and the segment 13e extends from the short-circuit point 14 in a direction perpendicular to the direction of extension of the one side of the ground plane 11. One end of the segment 13d is connected to the other end of the segment 13e. The segment 13d extends from a position near the center of the substrate 10 toward the left side surface in parallel to the one side of the ground plane 11.

A segment 13c of the unicursal-line conductor 13 is disposed on the back surface 10b of the substrate 10 so as to be opposed to the segments 13b and 13d via the substrate 10. The segment 13c extends in parallel to the segments 13b and 13d. A right end portion of the segment 13b is connected to the segment 13c on the back surface 10b via a via-hole 131 in the substrate 10. A left end portion of the segment 13d is connected to the segment 13c on the back surface 10b via a via-hole 132 in the substrate 10.

In FIG. 20, the feed point 12 is disposed on the right side of the short-circuit point 14, as viewed from the top surface 10a side of the substrate 10. Alternatively, the feed point 12 may be disposed on the left side of the short-circuit point 14.

FIG. 21 shows an analysis result of the electric field distribution of the coupler 1 of FIG. 20. In FIG. 21, a part with a higher electric field is indicated in a color with a higher density. In addition, arrows in FIG. 21 indicate the directions of high-frequency currents. It is understood, from FIG. 21, that a high electric field is generated at the parallel segment portion of the unicursal-line conductor 13, and the electric field of the ground plane 11 is low. Only common current components flow in the parallel segment portion. Currents in opposite directions flow in the segments 13a and 13e of the unicursal-line conductor 13. Thus, the parallel segment portion of the unicursal-line conductor 13 mainly contributes to electric field radiation, and a desired electric field radiation pattern can be generated.

FIG. 22 shows electric field radiation characteristics of the coupler 1 of FIG. 20. FIG. 22 shows electric field radiation characteristics (Eφ, Eθ) corresponding to three frequencies, namely a central frequency (5.9 GHz) in a frequency band used by the coupler 1 for communication, and frequencies (5.6 GHz and 6.2 GHz) at both ends in the frequency band. The electric field radiation characteristics corresponding to 5.6 GHz are indicated by a solid line, the electric field radiation characteristics corresponding to 5.9 GHz are indicated by a broken line, and the electric field radiation characteristics corresponding to 6.2 GHz are indicated by a dotted line.

From FIG. 22, it is understood that in the communication direction (+Y direction), i.e. the direction of 90°, a stable electric field radiation intensity in a range of −9.0 to −11.3 dB is obtained at each of the three frequencies. In addition, as is understood from FIG. 22, in the direction toward the inside of the apparatus (−Y direction), i.e. the direction of 270°, an electric field radiation intensity in a range of −13.0 to −15.5 dB is obtained at each of the three frequencies, and the electric field radiation intensity in the direction toward the inside of the apparatus (−Y direction) is lower by 3 to 5 dB than the electric field radiation intensity in the communication direction (+Y direction). This directivity is desirable for the coupler which is incorporated in the apparatus.

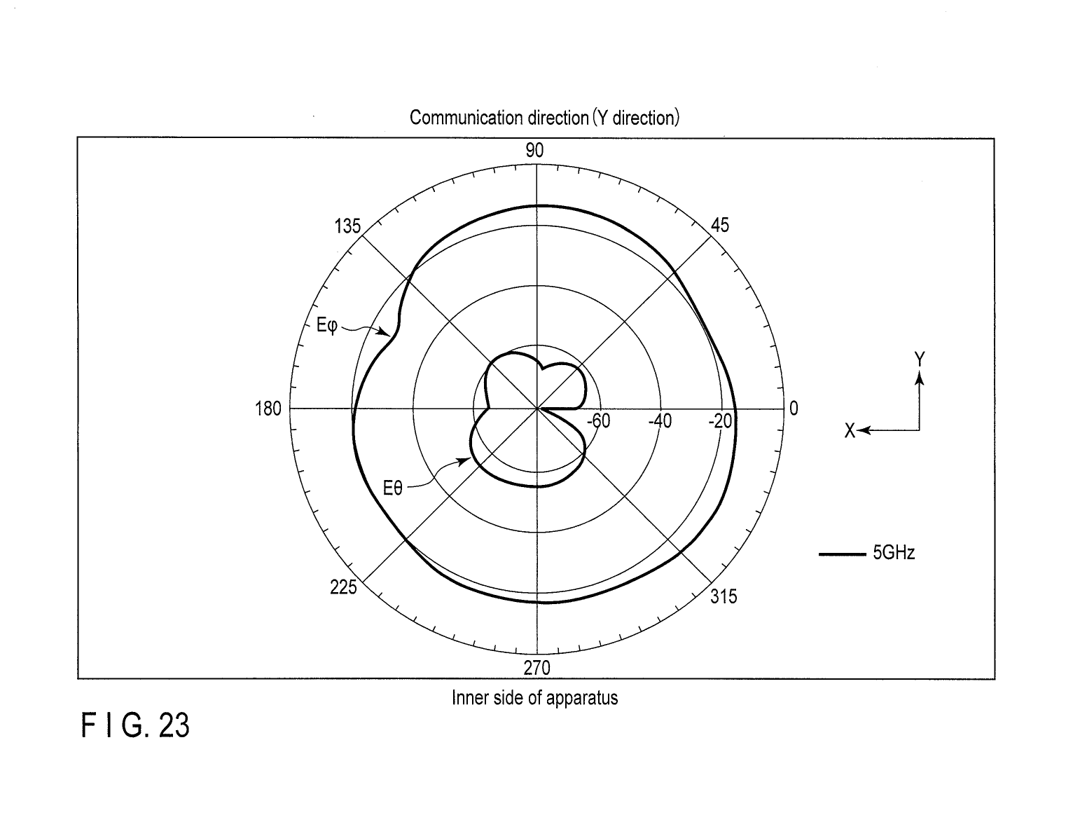

FIG. 23 shows electric field radiation characteristics of the coupler 1 having the structure of FIG. 7, which is mounted on one surface of the substrate. FIG. 23 shows electric field radiation characteristics (Eφ, Eθ) corresponding to a frequency of 5 GHz. When the frequency is less than 5 GHz, currents in opposite phases flow in the parallel segment portion of the coupler 1. When the frequency increases to 5 GHz or more, the coupler 1 starts to operate in the common mode, and a stable electric field radiation intensity is obtained in the communication direction (+Y direction), i.e. the direction of 90°.

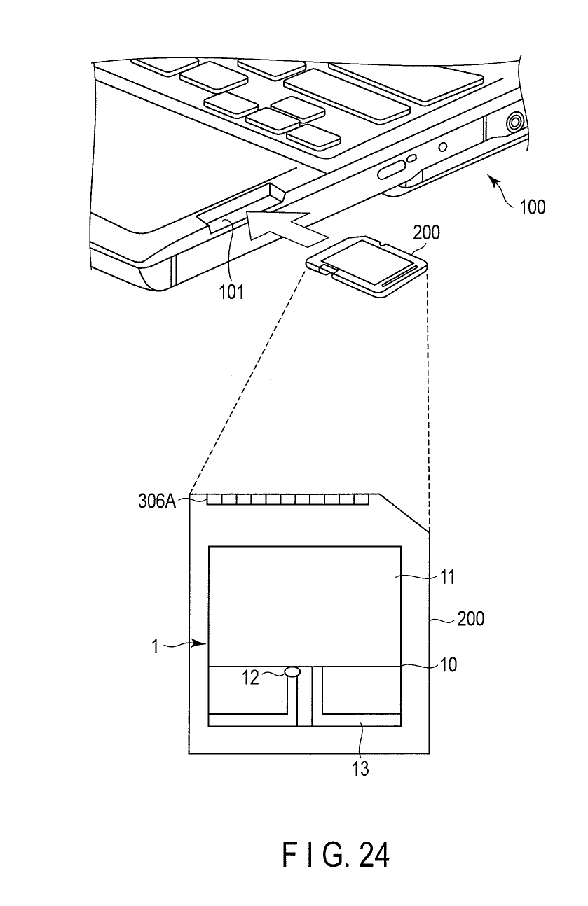

The coupler 1 of the embodiment can be mounted on one surface of the substrate or on both surfaces of the substrate. Thus, as shown in FIG. 24, the coupler 1 may be provided in a card device (e.g. SD card) 200 which is detachably inserted in a card slot of an electronic apparatus 100. In this case, one end portion of the card device 200 is provided with a connector 306A for an interface with a host. The coupler 1 is disposed in the card device 200 such that the parallel segment portion of the unicursal-line conductor 13 is positioned on the other end side of the card device 200. A printed circuit board may be used as the substrate 10 of the coupler 1. Not only the coupler 1 but also a communication device, which is configured to execute close proximity wireless transfer via the coupler 1, may be provided on the substrate 10.

As has been described above, in the present embodiment, the electrical length L1 of the unicursal-line conductor 13 is set at a value within the range of λ to 2λ, the electrical length of the parallel segment portion of the unicursal-line conductor 13 is set at a value within the range of λ/2 to λ, and the electrical length L3 between the feed point 12 and short-circuit point 14 is set at λ/5 or less. Thus, since the input impedance of the coupler 1 can be increased and a large high-frequency current in the same direction can be let to flow in the parallel segment portion, the structure which can reduce inflow of high-frequency current to the ground plane is realized. Therefore, a sufficient radiation efficiency can be obtained even in the condition that a peripheral metal is present.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coupler comprising:
a ground plane;
a feed point connected to the ground plane; and
an element having a unicursal pattern, the element comprising a first end connected to the feed point and a second end connected to a short-circuit point on the ground plane,
wherein an electrical length of the element is greater than or equal to a wavelength corresponding to a central frequency of a desired frequency band, and is less than or equal to twice the wavelength,
wherein an electrical length between the feed point and the short-circuit point on the ground plane is less than or equal to ⅕ of the wavelength,
wherein the element comprises
a first segment disposed on a first plane, and
a second segment disposed on the first plane or on a second plane that is parallel to and opposite the first plane and separated from the first plane with a gap, the second segment being parallel to the first segment, and
wherein an electrical length of the first segment is greater than or equal to ½ of the wavelength and less than or equal to the wavelength and an electrical length of the second segment is greater than or equal to ½ of the wavelength and less than or equal to the wavelength.

2. The coupler of claim 1,
wherein the feed point and the short-circuit point are disposed on an intermediate portion of one side of the ground plane.

3. The coupler of claim 1, further comprising a dielectric having a rectangular parallelepiped shape,
wherein the first plane is a first surface of the dielectric, and
wherein the second plane is a second surface of the dielectric, the second surface being positioned on a back side of the first surface.

4. The coupler of claim 3,
wherein the first segment and the second segment are disposed on the first surface of the dielectric.

5. The coupler of claim 3,
wherein the first segment is disposed on the first surface of the dielectric, and
wherein the second segment is disposed on the second surface of the dielectric.

6. The coupler of claim 5,
wherein the first segment or the second segment comprises a third portion which is not opposed to the other of the first segment and the second segment.

7. The coupler of claim 5,
wherein the first segment or the second segment has a first width, and
wherein the other of the first segment and the second segment has a second width that is less than the first width,
wherein the other of the first segment and the second segment is opposed to the first segment or the second segment via the dielectric, and
wherein the other of the first segment and the second segment extends along a center line in a longitudinal direction of the first segment or the second segment.

8. The coupler of claim 1,
wherein the coupler is provided in a card device configured to be detachably inserted in a card slot of an electronic apparatus.

9. A coupler comprising:
a dielectric substrate;
a ground plane disposed on a first surface of the dielectric substrate;
a feed point disposed on the first surface of the dielectric substrate and connected to a side of the ground plane; and
an element having a unicursal pattern, the element comprising a first end connected to the feed point, and a second end connected to a short-circuit point on the ground plane,
wherein an electrical length of the element is greater than or equal to a wavelength corresponding to a central frequency of a desired frequency band, and less than or equal to twice the wavelength,
wherein an electrical length between the feed point and the short-circuit point on the ground plane is less than or equal to ⅕ of the wavelength,
wherein the element comprises a first segment disposed on the first surface of the dielectric substrate and extending in parallel to the one side of the ground plane, and a second segment disposed on the first surface of the dielectric substrate or on a second surface of the dielectric substrate, the second segment extending in parallel to the first segment, and
wherein an electrical length of each of the first segment and the second segment is greater than or equal to ½ of the wavelength, and less than or equal to the wavelength.

10. The coupler of claim 9,
wherein the feed point and the short-circuit point are disposed on an intermediate portion of the side of the ground plane.
